(19) United States
(12) Patent Application Publication
(10) Pub. No.: US 2015/0010267 A1
(43) Pub. Date: Jan. 8, 2015

(54) INTERCONNECTION BETWEEN SILICON PHOTONICS DEVICES AND OPTICAL FIBERS

(71) Applicant: Mellanox Technologies Ltd., Yokneam (IL)

(72) Inventors: Shmuel Levy, Kyriat Tivon (IL); Avner Badihi, Nataf (IL); Sylvie Rockman, Zichron Yaakov (IL); Elad Mentovich, Tel Aviv (IL)

(21) Appl. No.: 13/935,511

(22) Filed: Jul. 4, 2013

(51) Int. Cl. G02B 6/32

(52) U.S. Cl. CPC G02B 6/32
USPC 385/14; 438/31

(57) ABSTRACT

An apparatus includes a Silicon Photonics (SiP) device and a ferrule. The SiP includes multiple optical waveguides. The ferrule includes multiple optical fibers for exchanging optical signals with the respective optical waveguides of the SiP device. In some embodiments, an array of micro-lenses is configured to couple the optical signals between the optical waveguides of the SiP device and the respective optical fibers of the ferrule. In some embodiments, a polymer layer is placed between the SiP device and the ferrule, and includes multiple polymer-based Spot-Size Converters (SSCs) that are configured to couple the optical signals between the optical waveguides of the SiP device and the respective optical fibers of the ferrule.

### CROSS-REFERENCE TO RELATED APPLICATIONS

This application is related to a patent application entitled “Polymer-Based Interconnection between Silicon Photonics Devices and Optical Fibers,” Attorney docket no. 1058-1111.1, filed on even date, whose disclosure is incorporated herein by reference.

### FIELD OF THE INVENTION

The present invention relates generally to optical interconnection, and particularly to methods and systems for interconnection between Silicon Photonics (SiP) devices and optical fibers.

### BACKGROUND OF THE INVENTION

Silicon Photonics (SiP) is a technology that enables entire optical systems to be manufactured using Silicon processes, with Silicon as the optical medium. Various optical components, such as interconnects and signal processing components, may be fabricated and integrated in a single SiP device. Some SiP devices are fabricated on a Silica substrate, a technology that is often referred to as Silicon On Insulator (SOI).

### SUMMARY OF THE INVENTION

An embodiment of the present invention that is described herein provides an apparatus including a Silicon Photonics (SiP) device, a ferrule and an array of multiple micro-lenses. The SiP includes multiple optical waveguides. The ferrule includes multiple optical fibers for exchanging optical signals with the respective optical waveguides of the SiP device. The micro-lenses are configured to couple the optical signals between the optical waveguides of the SiP device and the respective optical fibers of the ferrule.

In some embodiments, the optical waveguides are characterized by a first optical spot size, the optical fibers are characterized by a second optical spot size, and the micro-lenses are configured to focus or collimate the optical signals so as to convert between the first and second optical spot sizes.

In some embodiments, the optical waveguides are spaced from one another with a first pitch, the ferrule includes positions for receiving the optical fibers with a second pitch that is finer than the first pitch, and the optical fibers are placed in a partial subset of the positions in the ferrule that match the first pitch. In an example embodiment, the first pitch includes 750 μm and the second pitch includes 250 μm. In a disclosed embodiment, the SiP device includes one or more alignment markers such that, when the optical fibers and the micro-lenses are positioned accurately against the optical waveguides, the alignment markers are aligned with respective positions of the ferrule that are not occupied by the optical fibers.

In another embodiment, the optical fibers have first ends that terminate on a face of the ferrule for coupling to the optical waveguides, and second ends that extend in a pig-tail from the ferrule. In an alternative embodiment, the optical fibers have first ends that terminate on a first face of the ferrule for coupling to the optical waveguides, and second ends that terminate on a second face of the ferrule.

In an embodiment, the ferrule includes a bottom part and a top part, which are configured to receive the optical fibers therebetween. In another embodiment, the micro-lenses include Graded Index (GRIN) lenses. The GRIN lenses may be fabricated using Multi-Mode Fibers (MMF).

There is additionally provided, in accordance with an embodiment of the present invention, a method including providing a Silicon Photonics (SiP) device including multiple optical waveguides, and providing a ferrule including multiple optical fibers for exchanging optical signals with the respective optical waveguides of the SiP device. An array of multiple micro-lenses is connected between the SiP device and the ferrule, for coupling the optical signals between the optical waveguides of the SiP device and the respective optical fibers of the ferrule.

There is also provided, in accordance with an embodiment of the present invention, apparatus including a Silicon Photonics (SiP) device, a ferrule and a polymer layer. The SiP device includes multiple optical waveguides. The ferrule includes multiple optical fibers for exchanging optical signals with the respective optical waveguides of the SiP device. The polymer layer is placed between the SiP device and the ferrule and includes multiple polymer-based Spot-Size Converters (SSCs) that are configured to couple the optical signals between the optical waveguides of the SiP device and the respective optical fibers of the ferrule.

In an embodiment, the optical waveguides terminate on a face of the SiP device, and the polymer layer, including the SSCs, is disposed on the face. In another embodiment, the optical waveguides terminate on a face of the SiP device with respective tapered tips, which are aligned with the respective polymer-based SSCs of the polymer layer. In yet another embodiment, the optical waveguides terminate on a face of the SiP device, and the polymer-based SSCs have a variable refraction index that varies progressively between the face of the SiP device and the ferrule.

In still another embodiment, the optical waveguides are characterized by a first optical spot size, the optical fibers are characterized by a second optical spot size, and the polymer-based SSCs are configured to focus or collimate the optical signals so as to convert between the first and second optical spot sizes.

In a disclosed embodiment, the optical waveguides are spaced from one another with a first pitch, the ferrule includes positions for receiving the optical fibers with a second pitch that is finer than the first pitch, and the optical fibers are placed in a partial subset of the positions in the ferrule that match the first pitch. In an example embodiment, the first pitch includes 750 μm and the second pitch includes 250 μm. In an embodiment, the SiP device includes one or more alignment markers such that, when the optical fibers are positioned accurately against the SSCs and the optical waveguides, the alignment markers are aligned with respective positions of the ferrule that are not occupied by the optical fibers.

In an embodiment, the optical fibers have first ends that terminate on a face of the ferrule for coupling to the optical waveguides, and second ends that extend in a pig-tail from the ferrule. In an alternative embodiment, the optical fibers have first ends that terminate on a first face of the ferrule for coupling to the optical waveguides, and second ends that terminate on a second face of the ferrule. In some embodiment, the ferrule includes a bottom part and a top part, which are configured to receive the optical fibers therebetween.

There is further provided, in accordance with an embodiment of the present invention, a method including providing a Silicon Photonics (SiP) device including multiple optical waveguides, and providing a ferrule including multiple optical fibers for exchanging optical signals with the respective optical waveguides of the SiP device. A polymer layer is placed between the SiP device and the ferrule. The polymer layer includes multiple polymer-based Spot-Size Converters (SSCs) for coupling the optical signals between the optical waveguides of the SiP device and the respective optical fibers of the ferrule.

The present invention will be more fully understood from the following detailed description of the embodiments thereof, taken together with the drawings in which:

### BRIEF DESCRIPTION OF THE DRAWINGS

FIG. 1 is an exploded isometric view of an optical interconnection assembly, in accordance with an embodiment of the present invention;

FIG. 2 is an isometric view of an optical ferrule, in accordance with an embodiment of the present invention; and

FIGS. 3 and 4 are schematic top views of optical interconnection assemblies, in accordance with embodiments of the present invention.

### DETAILED DESCRIPTION OF EMBODIMENTS

### Overview

Interconnection between Silicon Photonics (SiP) devices and optical fibers is technologically challenging, because of the different physical characteristics of the two media. For example, SiP waveguides typically have a diameter on the other of 3 μm and are spaced from one another with a pitch on the order of 750 μm. Single-mode optical fibers, on the other hand, typically have a core diameter on the other of 9 μm, and optical ferrules typically have a fiber-to-fiber pitch on the order of 250 μm. when interconnecting optical waveguides of a SiP device to respective optical fibers, the differences in pitch and diameter should be bridged with low cost and minimal performance degradation.

Embodiments of the present invention that are described herein provide improved methods and apparatus for interconnecting SiP devices and optical fibers. In a typical embodiment, a SiP device comprises multiple optical waveguides, with a 750 μm pitch and 3 μm diameter, which terminate on a certain face of the device. The waveguides are to be connected to a ferrule of optical fibers, having a 250 μm pitch and 9 μm diameter.

In some embodiments, the interconnection between the waveguides and the fibers is performed by an array of micro-lenses that is placed between the SiP device and the ferrule (e.g., embedded in the ferrule). The micro-lenses are designed to focus or collimate the light so as to convert between the 3 μm diameter of the waveguides and the 9 μm diameter of the fibers.

In alternative embodiments, the interconnection between the waveguides and the fibers is performed by a layer of polymer that is disposed on the face of the SiP device. The polymer layer comprises multiple polymer-based Spot Size Converters (SSCs), one SSC disposed next to the end of each waveguide. In one example embodiment, the ends of the waveguides are tapered, and the resulting pointed ends of the waveguides feed the polymer-based SSCs. In another example embodiment, the polymer-based SSCs comprise multiple polymer layers that gradually vary in refraction index.

In an example embodiment, pitch matching is performed by only partially populating the fiber positions of the ferrule, in a manner that fits the pitch or spacing between waveguides. For example, a conventional MT-12 ferrule has twelve fiber positions with a pitch of 250 μm. Populating only the second, fifth, eighth and eleventh positions with fibers produces a pitch of 750 μm that matches the pitch of the SiP waveguides.

In some embodiments, some of the unpopulated positions of the ferrule are used for aligning the ferrule and the waveguides. In an example embodiment, the face of the SiP device is marked with alignment marks (typically etched). The alignment marks are positioned against the desired locations of the first and twelfth positions of the MT-12 ferrule. During assembly, these alignment marks can be used for aligning the ferrule with the SiP device using automatic optical alignment. The resulting alignment accuracy between the fiber ends and the waveguide ends is on the order of ±0.5 μm or better.

The disclosed techniques enable low-cost and high-performance interconnection between SiP devices and optical fibers. These techniques eliminate the need for costly and cumbersome spot size converters.

### Example Lens-Based Interconnect Configurations

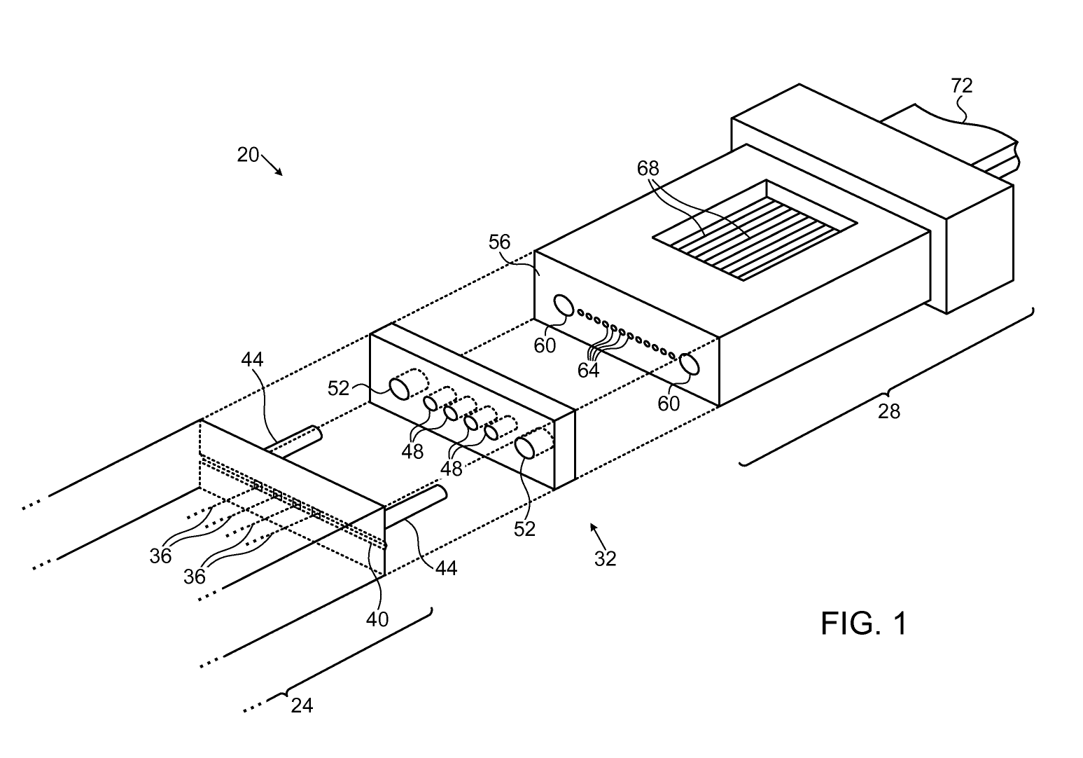

FIG. 1 is an exploded isometric view of an optical interconnection assembly 20, in accordance with an embodiment of the present invention. Assembly 20 comprises a Silicon Photonics (SiP) device 24 that is connected to a ferrule 28 of optical fibers using a planar micro-lens array 32. SiP device 24 may comprise any suitable optical components and may implement any suitable optical processing function, such as optical communication, routing or switching.

In some embodiments, SiP device 24 exchanges optical signals with external devices using an array of optical waveguides 36. In the present example, device 24 comprises four waveguides 36 that terminate on a certain face of the device. Waveguides 36 may be used for transmitting optical signals out of SiP device 24 and/or for receiving signals into the SiP device. The face of device 20 has a V-groove 40 in which waveguides 36 terminate.

In the embodiment of FIG. 1, waveguides 36 have a square or rectangular cross section having a width of 3 μm (and thus an optical spot size of this order). The spacing between waveguides 36 (“pitch”) in this example is 750 μm. The optical layers of SiP device 20 are fabricated on an insulator (e.g., silica) in a Silicon On Insulator (SOI) configuration. Assuming an eight-inch wafer, the insulator thickness is 720 μm.

Ferrule 28 connects waveguides 36 of SiP device 24 to respective ends of single-mode optical fibers 68. Ferrule 28 may be made of bakelite or other plastic, glass, or any other suitable material. The optical fibers leave the ferrule bundled in an optical cable 72. Fibers 68 may comprise, for example, SMF-28 fibers. Cable 72 may comprise an eight-fiber ribbon (comprising four fibers for transmission and four fibers for reception, supporting two ferrules such as ferrule 28). The ends of fibers 68 terminate on a front face 56 of ferrule 28. In the present example, ferrule 28 comprises a standard MT-12 ferrule, which is capable of supporting twelve fibers. Front face 56 of ferrule 28 thus comprises a row of twelve holes 64 for housing respective fiber ends. The spacing between holes 64, i.e., the pitch of ferrule 28, is 250 μm. In the present embodiment, the core diameter of fibers 68 is 9 μm (and the fibers' optical spot size is of this order).

In order to connect waveguides 36 to fibers 68, the differences in optical spot size (3 μm vs. 9 μm) and in pitch (750 μm vs. 250 μm) should be bridged. In some embodiments, the pitch difference is bridged by populating only a subset of holes (“positions”) 64 of ferrule 28 with fibers. In an example embodiment, the ferrule comprises only four fibers fitted in the second, fifth, eights and eleventh positions (out of the twelve possible positions 64). This configuration produces an actual pitch of 750 μm between the four fibers. This pitch matches the 750 μm pitch of waveguides 36.

In some embodiments, array 32 comprises four micro-lenses 48, each designed to convert between the 3 μm and 9 μm spot size of waveguides 36 and fibers 68, respectively. Micro-lenses 48 are spaced 750 μm from one another, so as to match the pitch of waveguides 36 and fibers 68. Any suitable micro-lens technology can be used for manufacturing micro-lenses 48. In one embodiment, the micro-lenses comprise Graded Index (GRIN) lenses made of Multi-Mode Fibers (MMF). Further alternatively, as will be described in greater detail below, various other kinds of spot-size conversion assemblies can be placed between SiP device 24 and ferrule 28.

In the present embodiment, when assembling assembly 20, the SiP device, micro-lens array and ferrule are aligned to one another using alignment pins 44 that extend from the face of SiP device 24. Pins 44 pass through respective alignment holes 52 in micro-lens array 32, and then fit into alignment holes 60 on face 56 of ferrule 28.

In alternative embodiments, any other suitable attachment and alignment means can be used instead of guide pins 44. For example, the SiP device, micro-lens array and ferrule may be attached to a suitable flange or base-plate (e.g., glued to a common glass bar). A suitable curing process, e.g., heat or Ultra-Violet (UV) curing, can be used for gluing the SiP device, micro-lens array and ferrule to the common glass support.

In some embodiments, array 32 is embedded in ferrule 28. In alternative embodiments, array 32 and ferrule 28 are separate modules that are connected to one another during manufacturing of assembly 20.

In embodiments, an additional high-accuracy alignment is performed between ferrule 28 and device 24, in order to minimize optical loss in the waveguide-fiber interface. In some embodiments, the face of the SiP device is marked (typically etched) with alignment marks. The alignment marks are positioned in groove 44, against the desired locations of the first and twelfth holes 64 of ferrule 28. During assembly, these alignment marks can be used for aligning ferrule 28 with SiP device 24 and array 32 using automatic optical alignment.

In an example embodiment, two alignment marks are etched against the desired positions of the first and twelfth (unpopulated) holes 64. By automatically aligning the first and twelfth holes 64 with the alignment marks, alignment accuracy on the order of ±0.5 μm or better can be achieved. Alternatively, any other suitable number of alignment marks can be used, at any desired locations. When multiple SiP devices are fabricated on a wafer and then diced, the alignment marks may be etched on the wafer, on the dicing line that separates between the SiP devices.

In the embodiment of FIG. 1, ferrule 28 has a pigtail configuration in which fibers 68 leave the ferrule in a bundled cable 72. In some embodiments, ferrule 28 is manufactured by inserting fibers 68 until their ends protrude from face 56, and then polishing the fiber ends to make them flush with face 56.

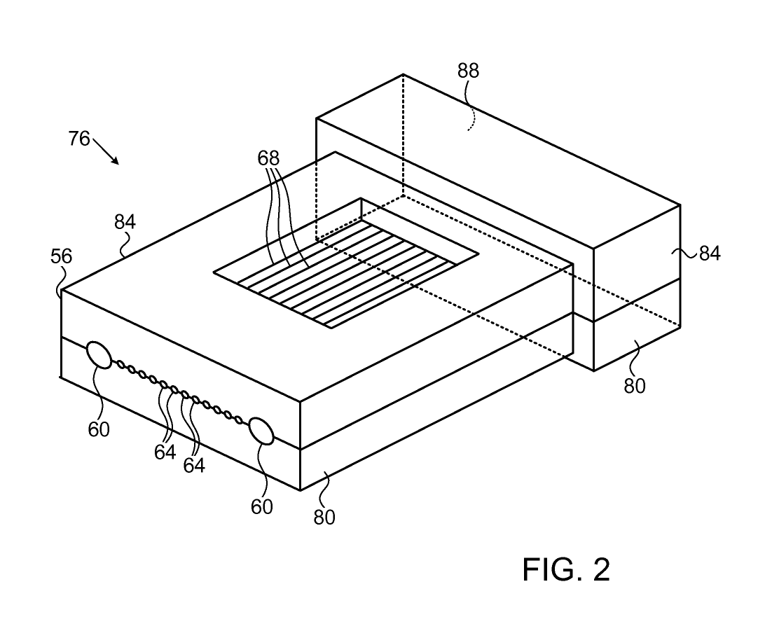

FIG. 2 is an isometric view of an optical ferrule 76, in accordance with an alternative embodiment of the present invention. Ferrule 76 can be used instead of ferrule 28 in device 20 of FIG. 1 above. Ferrule 76 differs from ferrule 28 in two aspects - Fiber placement method and fiber back-side interface.

As explained above, the body of ferrule 28 of FIG. 1 comprises a single block of material (e.g., Bakelite), into which fibers 68 are inserted. The body of ferrule 76, in contrast, comprises a bottom part 80 and a top part 84 that are connected to one another during assembly. Additionally, unlike the pigtail configuration of ferrule 28, fibers 68 in ferrule 76 are flush with the ferrule faces at both ends. In other words, ferrule 76 functions as an adapter.

Typically part 80 and/or 84 comprises V-grooves or other suitable grooves for receiving fibers 68. Ferrule 76 is assembled by placing fibers 68 in the appropriate grooves (e.g., the second, fifth, eighth and eleventh grooves) of part 80, covering part 80 with part 84, and then polishing both ends of the fibers to make them flush with the respective opposite faces of the ferrule. In some embodiments, a rear face 88 of ferrule 76 comprises pins (not shown in the figure) for alignment.

In alternative embodiments, a ferrule can be manufactured with any desired combination of adapter/pigtail and fiber insertion/placement configuration. For example, a ferrule may comprise top and bottom parts as in FIG. 2, and a pigtail configuration as in FIG. 1. Alternatively, a ferrule may comprise a single-part body as in FIG. 1, and an adapter configuration as in FIG. 2.

### Example Polymer-Based Interconnect Configurations

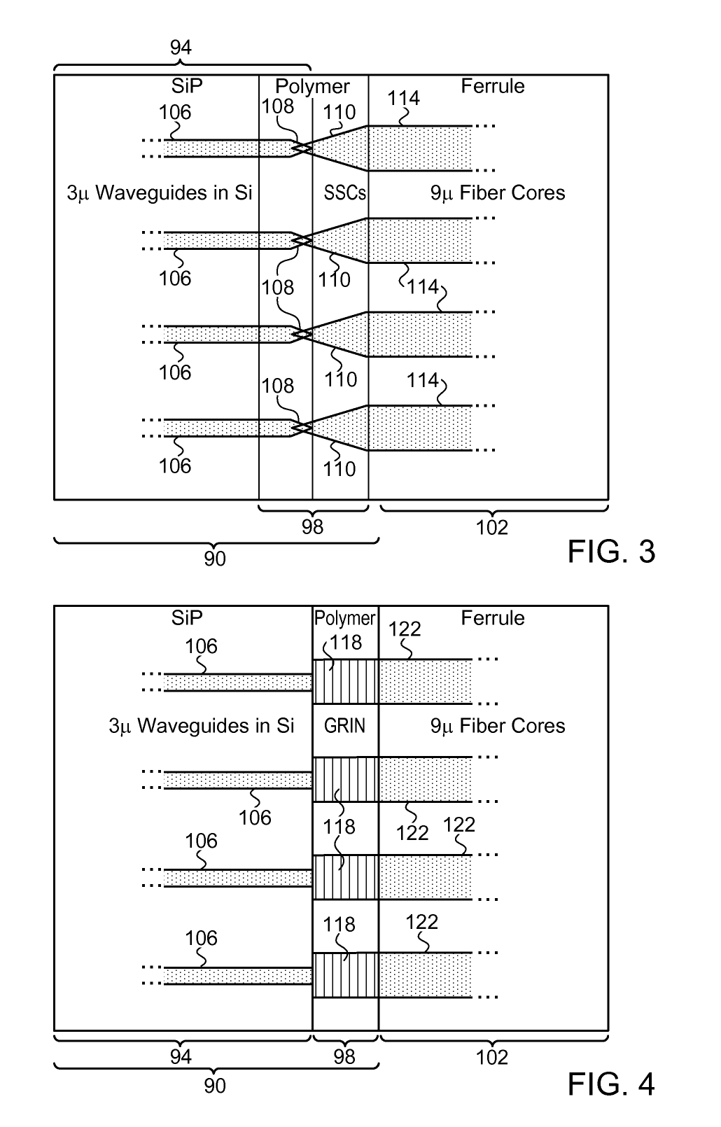

In the embodiments described above, spot size conversion is performed by an array of micro-lenses. In the alternative embodiments described in FIGS. 3 and 4 below, spot size conversion is carried out by polymer-based spot size converters that are disposed on the face of the SiP device. The configurations of FIGS. 3 and 4 below can be used with any of the ferrule configurations described herein, e.g., pigtail (as in FIG. 1), adapter (as in FIG. 2), single-part body (as in FIG. 1) dual-part body (as in FIG. 2), and/or partially populated fiber positions for pitch matching.

FIG. 3 is a schematic top view of an optical interconnection assembly, in accordance with an embodiment of the present invention. The left-hand side of the figure shows a SiP device 94. The SiP device comprises four 3 μm optical waveguides 106, which are fabricated in silicon. As can be seen in the figure, the ends of waveguides 106 are tapered, so that the waveguides terminate on or near the face of the SiP device with pointed tips 108.

Although the figure shows tapering that converges to a point, in other embodiments the ends of the waveguides narrow-down to a finite aperture that is smaller than the width or diameter of the waveguides. Although the figure shows a two-dimensional top view, the tapering pattern of the waveguide ends is typically three-dimensional, e.g., conical tapering. Tapering of this sort makes the waveguide ends more isotropic.

The right-hand side of the figure shows a ferrule 102 with four 9μ-core fibers 114. Ferrule 114 may comprise, for example, ferrule 28 of FIG. 1 or ferrule 76 of FIG. 2.

In order to perform spot size conversion, a polymer layer 98 is disposed (e.g., grown, diffused or otherwise attached) on SiP device 94, so as to produce a composite device 90. As part of disposing the polymer layer, polymer-based Spot Size Converters (SSCs) 110 are fabricated using the polymer. Polymer-based SSCs 110 convert between the 3 μm spot size of waveguides 106 and the 9μ spot size of fibers 114.

In the present example, polymer layer 98 is disposed above SiP device 94, so as to produce some overlap between ends 108 of optical waveguides 106 and SSCs 110. In this manner, each end 108 serves as a feed that radiates into the respective SSC 110. Each SSC 110 has a three-dimensional tapered geometry, resembling a horn antenna. In alternative embodiments, any other suitable coupling scheme can be used for coupling the SSCs to the ends of the optical waveguides.

FIG. 4 is a schematic top view of an optical interconnection assembly, in accordance with another alternative embodiment of the present invention. In the present example, the ends of waveguides 106 are not tapered. Polymer layer 118 comprises Graded Index (GRIN) SSCs 118 that perform the spot size conversion between waveguides 106 and fibers 122. SSCs 118 typically comprise multiple layers of polymer that gradually vary in refraction index, or a variable-index polymer whose refraction index is modulated during production.

The configurations shown in FIGS. 1-4 above are example configurations that are depicted purely by way of example. In alternative embodiments, any other suitable configurations can be used. Such alternative embodiments may comprise any suitable number of waveguides, fibers, lenses or SSCs of any suitable dimensions, material compositions and/or mechanical configurations.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. Apparatus, comprising:
a Silicon Photonics (SiP) device, which comprises multiple optical waveguides;
a ferrule, which comprises multiple optical fibers for exchanging optical signals with the respective optical waveguides of the SiP device; and
an array of multiple micro-lenses, which are configured to couple the optical signals between the optical waveguides of the SiP device and the respective optical fibers of the ferrule.

2. The apparatus according to claim 1, wherein the optical waveguides are characterized by a first optical spot size, wherein the optical fibers are characterized by a second optical spot size, and wherein the micro-lenses are configured to focus or collimate the optical signals so as to convert between the first and second optical spot sizes.

3. The apparatus according to claim 1, wherein the optical waveguides are spaced from one another with a first pitch, wherein the ferrule comprises positions for receiving the optical fibers with a second pitch that is finer than the first pitch, and wherein the optical fibers are placed in a partial subset of the positions in the ferrule that match the first pitch.

4. The apparatus according to claim 3, wherein the first pitch comprises 750 μm and the second pitch comprises 250 μm.

5. The apparatus according to claim 3, wherein the SiP device comprises one or more alignment markers such that, when the optical fibers and the micro-lenses are positioned accurately against the optical waveguides, the alignment markers are aligned with respective positions of the ferrule that are not occupied by the optical fibers.

6. The apparatus according to claim 1, wherein the optical fibers have first ends that terminate on a face of the ferrule for coupling to the optical waveguides, and second ends that extend in a pig-tail from the ferrule.

7. The apparatus according to claim 1, wherein the optical fibers have first ends that terminate on a first face of the ferrule for coupling to the optical waveguides, and second ends that terminate on a second face of the ferrule.

8. The apparatus according to claim 1, wherein the ferrule comprises a bottom part and a top part, which are configured to receive the optical fibers therebetween.

9. The apparatus according to claim 1, wherein the micro-lenses comprise Graded Index (GRIN) lenses.

10. The apparatus according to claim 9, wherein the GRIN lenses are fabricated using Multi-Mode Fibers (MMF).

11. A method, comprising:
providing a Silicon Photonics (SiP) device comprising multiple optical waveguides;
providing a ferrule comprising multiple optical fibers for exchanging optical signals with the respective optical waveguides of the SiP device; and
connecting between the SiP device and the ferrule an array of multiple micro-lenses, for coupling the optical signals between the optical waveguides of the SiP device and the respective optical fibers of the ferrule.

12. The method according to claim 11, wherein the optical waveguides are characterized by a first optical spot size, wherein the optical fibers are characterized by a second optical spot size, and wherein coupling the optical signals comprises focusing or collimating the optical signals using the micro-lenses so as to convert between the first and second optical spot sizes.

13. The method according to claim 11, wherein the optical waveguides are spaced from one another with a first pitch, wherein the ferrule comprises positions for receiving the optical fibers with a second pitch that is finer than the first pitch, and wherein the optical fibers are placed in a partial subset of the positions in the ferrule that match the first pitch.

14. The method according to claim 13, wherein the first pitch comprises 750 μm and the second pitch comprises 250 μm.

15. The method according to claim 13, wherein providing the SiP device comprises marking one or more alignment markers on the SiP device such that, when the optical fibers and the micro-lenses are positioned accurately against the optical waveguides, the alignment markers are aligned with respective positions of the ferrule that are not occupied by the optical fibers.

16. The method according to claim 11, wherein providing the ferrule comprises placing the optical fibers in the ferrule such that first ends of the optical fibers terminate on a face of the ferrule for coupling to the optical waveguides, and second ends of the optical fibers extend in a pig-tail from the ferrule.

17. The method according to claim 11, wherein providing the ferrule comprises placing the optical fibers in the ferrule such that first ends of the optical fibers terminate on a first face of the ferrule for coupling to the optical waveguides, and second ends of the optical fibers terminate on a second face of the ferrule.

18. The method according to claim 11, wherein providing the ferrule comprises providing a bottom part and a top part of the ferrule, for receiving the optical fibers therebetween.

19. The method according to claim 11, wherein the micro-lenses comprise Graded Index (GRIN) lenses.

20. The method according to claim 19, wherein the GRIN lenses are fabricated using Multi-Mode Fibers (MMF).
